(19) United States
(12) Patent Application Publication
(10) Pub. No.: US 2008/0235767 A1
(43) Pub. Date: Sep. 25, 2008

(54) Method of Controlling Access to a Communication Network

(75) Inventor: Declan Patrick Kelly, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,183

(22) PCT Filed: Jan. 13, 2005
(86) PCT No.: PCT/IB2005/050147

§ 371 Date: Jul. 14, 2006

(30) Foreign Application Priority Data
Jan. 20, 2004 (EP) 04100167.8

(51) Int. Cl. G06F 1/00; H04L 29/06

(52) U.S. Cl. 726/3; 726/29

(57) ABSTRACT

A method of controlling access to infrastructure (40) is provided. The method pertains to a terminal (20) that can be communicatively coupled to the infrastructure (40). Moreover, the terminal (20) is arranged to include a computer processor (60) that can be coupled to an associated local memory device (70) capable of receiving data carriers (200a, 200b). The method involves a first step of arranging for the processor (60) to execute one or more software applications therein which are at least in part operable in a substantially seamless manner to a user (90) of the terminal (20) for accessing data content from one or more of the local memory device (70) and the infrastructure (40). The computer processor (60) is at least partially restricted regarding data content that it is capable of receiving from the infrastructure (40, 50) and/or requesting from the infrastructure (40, 50).

### FIELD OF THE INVENTION

The present invention relates to methods of controlling access to communication networks in situations where users of devices capable of being connected to the networks are potentially unaware of their devices coupling to sources of data in the networks; in particular, but not exclusively, the present invention relates to a method of controlling access to the Internet independence on a choice of data carrier. Moreover, the invention also relates to apparatuses operable to function according to the method; for example, the invention is pertinent to apparatuses which do not include software browsers for accessing communication networks such as the Internet and yet are arranged to execute user software, for example one or more Java applications which are capable of accessing these communication networks without users of the apparatus being necessarily aware of such access being made.

### BACKGROUND TO THE INVENTION

The Internet and similar contemporary data communication networks enable users to access a wide range of subject matter from data servers of the networks arranged to supply data content. Such users conventionally employ browser software applications executing on computer hardware, for example lap-top computers, coupled to the networks for accessing information at the servers. It is known that these browser applications can be configured on the computer hardware so as to access only certain categories of data content provided by the aforesaid servers. For example, the browser applications may be arranged to exclude certain classes of web-sites on the Internet, for example to avoid accessing sites capable of providing data content degraded by viruses or of supplying subject matter conventionally regarded to be in aesthetically bad taste.

It is known to control access to electronic content over a network. For example, European patent application EP 1, 267, 243 describes a method of transferring information from a data content supplier to a remote location. The content supplier includes one or more databases for supplying data content such as executable software programs (software applications), audio such as MP3 files, still images and pictures, data files, video and any combination of such types of data content. A user is located at the remote location and makes use of an authorizing hybrid optical disc having a ROM portion and a RAM portion. The ROM portion includes a pre-formed identification signature impressed thereinto which is difficult for a pirate to copy. The RAM portion is arranged to include user-specific encrypted information which personalizes the optical disc for that specific user. Moreover, the encrypted information in combination with the ROM identification signature provides a user-personalized secure signature. A content supplier authenticating the user presenting the user-personalized secure signature is able to determine whether or not the user is authorized to download selected information from the content supplier to memory at the remote location for use by the user. The aforesaid patent application is therefore directed to a problem of determining user access to data content stored in one or more databases, for example in return for payment and/or granted user access rights to the data content.

The inventor has appreciated that a problem rather different from those described in the foregoing can arise with regard to remote computing devices, for example media players, having included thereon computing capacity as well as data storage capacity for storing local data content. Such remote computing devices are arranged to execute one or more software applications capable of accessing data content stored locally in the devices and/or accessing data content stored remotely from the devices at one or more databases of a communication network, for example the Internet; these software applications are distinct from conventional browser software applications. For example, with regard to future DVD players and similar dedicated data content presenting devices that can be coupled to communication networks such as the Internet envisaged by the inventor, there will often be no explicit browser software included on the devices; the devices conveniently include a Java Virtual Machine for supporting Java software applications. Such Java applications can invoke communication software, for example Application Program Interfaces (APIs) such as Internet access APIs for using network features supported by the Java Virtual Machine. Since there is no explicit browser application software included in the contemporary DVD players, software applications executing on the DVD players are capable of accessing network data sites without the users being aware of this.

Thus, the inventor has perceived that the remote computing devices are capable of downloading unsuitable or potentially damaging data content without their users either being aware that such downloading is occurring or being able to prevent such downloading from occurring. In this respect, it is a contemporary trend to arrange for software applications executing on portable computing devices, for example mobile telephones and portable media players such as DVD-players, to exhibit seamless operation to their users when accessing different classes of data content from several sources. As a further problem, the inventor has appreciated that it is potentially feasible for certain undesirable software applications to be downloaded without the users being aware, the undesirable applications enabling third parties to monitor users' activities and hence encroach upon their privacy. Thus, the inventor has appreciated that a greater control of the selection of downloaded data content is desirable whilst also endeavouring to achieve a seamless-type operation to which users are contemporarily accustomed.

A further problem arises in that communication network databases, for example Internet web-sites, are not necessarily stable with time and can be subject to upgrades and updates; such upgrades and updates can arise without users being aware of them having been implemented. The inventor has appreciated that is beneficial to have an opportunity to avoid web-sites whose updated software is capable of causing the users device to malfunction on account of incompatibility.

### SUMMARY OF THE INVENTION

An object of the invention is to provide a method of providing users of computing devices with greater control of data content downloaded from one or more databases remote from the users and/or their devices.

According to a first aspect of the present invention, a method of controlling access to a communication network is provided, characterized in that the method includes the steps of:
(a) providing a device that can be communicatively coupled to the network, the device being arranged to include computing means coupling to associated local data storing means;
(b) arranging for the computing means to execute one or more software applications therein which are at least in part operable in a substantially seamless manner to a user of the device for accessing data content from one or more of the local storing means and the network;
(c) arranging for the computing means to be at least partially restricted regarding data content that it is capable of receiving from the network and/or requesting from the network.

The invention is of advantage in that it is capable of restricting an extent to which software applications can be unintentionally loaded into the computing means when such applications are capable of having access to data available within the device.

Preferably, in the method, the device is arranged to communicate with the network by software means other than one or more browser software applications. Use of software means other than a browser is beneficial in certain classes of products, for example dedicated media players such as DVD-players, where seamless product operation is to be presented to users of the products without the users being aware of the products accessing data sources remote from the products through a browser.

Preferably, in the method, the device is capable of being restricted according to one or more of the following categories:
(d) access/no access to the network;
(e) access to the network subject to user authorization;
(f) access to the network as defined in a parameter list maintained in association with the device; and
(g) access to the network as defined in association with a given data carrier compatible with the storing means.

These categories are of benefit in that they address principal categories of access which are likely to be of concern to the user.

Preferably, in the method, in step (e), the user is presented with a choice of whether or not to authorize on at least a first occasion that a new given data content delivering site in the network is to be accessed. Such an approach renders possible a subsequent apparently substantially seamless execution of software applications in the device while nevertheless providing the user with a high degree of initial control of choice of sources of data content usable by the device.

Preferably, in the method, the user is presented with one or more Uniform Resource Locators (URL) that he/she can authorize the device to access. Such a definition of access to a specific URL allows the user to avoid known problem web-sites which are known by their URLs.

Preferably, in the method, device can be set to be subject to a default degree of access to the network which can be overridden by at least one of:
(h) user's choice; and
(i) degree of access determined in association with a given data carrier presented to the storing means.

Preferably, in the method, the device is operable to return to a default state of access to the network when one or more of the following states have arisen: re-booted or powered down.

Preferably, in the method, the partial restriction applied to the computing means in step (c) is arranged to at least partially prevent software applications from being downloaded from the network to the device which are executable on the computing means to enable access from the network to data content present in the device.

Preferably, in the method, the degree of access to the network is dependent on one or more data carriers presented to the storing means. Thus, each data carrier inserted by the user into the device can have associated therewith a correspondingly defined degree of access. Such a linking of the degree of access to a particular data carrier is of advantage in that it circumvents a need for the user to have to reconfigure the device manually explicitly for each data carrier used with the device. Alternatively, or additionally, the degree of access may be determined by particular parameters carried on one or more data carriers, for example in response to a keyword such as “Disney” signifying a particular category of program data content.

Preferably, the network corresponds to the Internet and the device is a portable handheld apparatus, more preferably an optical disc data medium player or a DVD-player.

Preferably, in the method, the storing means is arranged to accept one or more optical memory discs, electronic memory modules, and magnetic discs as data carriers to provide executable software applications and/or data content to the computing means.

According to a second aspect of the present invention, a device is provided for communicating with a communication network, characterized in that the device is arranged to include computing means coupling to associated local data storing means, the computing means being operable in a substantially seamless manner to a user of the device for executing one or more software applications therein which are at least in part capable of accessing data content from one or more of the local storing means and the network, and the computing means is arranged to be at least partially restricted regarding data content that it is capable of receiving from the network and/or requesting from the network.

It will be appreciated that features of the invention are susceptible of being combined in any combination without departing from the scope of the invention.

### DESCRIPTION OF THE DIAGRAMS

Embodiments of the invention will now be described, by way of example only, with reference to the following diagrams, wherein:

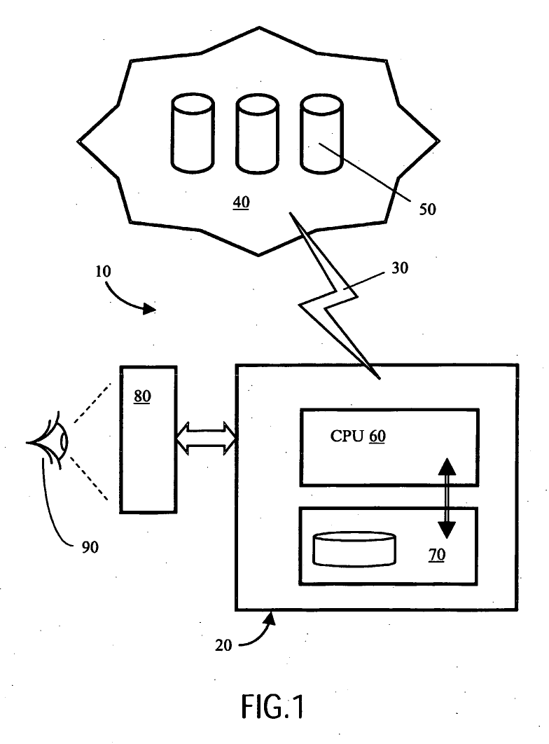

FIG. 1 is an illustration of a communication network including a remote terminal; and

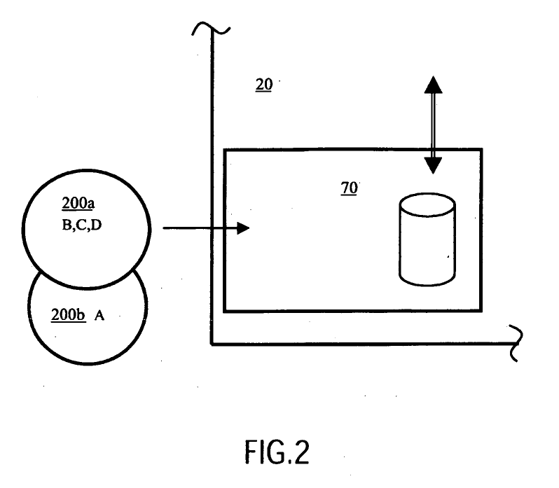

FIG. 2 is an illustration of the terminal arranged to accept data carriers for providing data content and/or software to the terminal.

### DESCRIPTION OF EMBODIMENTS OF THE INVENTION

In overview with regard to the present invention, the inventor has envisaged that a computer-based product including a computing device coupled to an associated memory device and also to a communication interface for connecting the product to one or more databases situated remotely from the product is preferably provided with a feature, implemented in hardware and/or software, which controls a degree to which a user of the product has access to the one or more databases, for example one or more servers coupled to the Internet; for example, the product is preferably a DVD player including a Java Virtual Machine capable of executing software stored on a DVD data carrier provided to the player, the data carrier including executable software applications and/or data content. The computing device can be configured by means of a set of configuration parameters to exhibit in operation various degrees of acceptance of categories of data content received at the product from the one or more databases and/or sent as requests for data content from the product to the one or more data bases. These configuration parameters may advantageously be selected for different software applications which can be executed on the computing device; for example, a first given software application may be authorized by a user of the device to access and/or receive data from the one or more databases whereas a second given software application may be authorized to have no access to the one or more databases. Intermediate degrees of access to the one or more databases and/or limited categories of data accepted from the one or more databases may also be selected by the user for each software application. More preferably, the software applications are introduced into the product through insertion of one or more data carriers into the product. Additionally, or alternatively, one or more of the software applications can be downloaded from the one or more databases. The aforesaid configuration parameters may advantageously be set for each of the data carriers; for example, each DVD data carrier usable with the product may have an associated set of configuration parameters which control a degree to which software applications included on the data carrier are capable, when executed within the product, of accessing data stored on databases remote from the product and/or included on the data carrier. For example, the user inserting a given data carrier, for example a proprietary “Blu-ray” optical disc data carrier as developed by the Philips Corporation, into the product will invoke an associated set of configuration parameters for that data carrier determining an extent to which software applications recorded on the data carrier can access data content on the one or more databases. Thus, one data carrier may be arranged so that its software applications have Internet access whereas another data carrier may be arranged so that its software applications are denied access to the Internet. The data parameters may be stored in other memory included in the product, for example in a non-volatile memory associated with the computing device of the product. Moreover, the configuration parameters can be either user-selectable or vendor-selectable, or selectable otherwise.

In order to elucidate the present invention further, an embodiment thereof will now be described with reference to FIG. 1.

In FIG. 1, a communication network is indicated generally by 10. The network 10 includes a remote terminal 20 coupled via a communication link 30 to a network infrastructure 40 including one or more servers, for example a server 50, operable to provide one or more accessible databases. The communication link 30 is a wireless link, a wire link, an optical link, some other link, or a combination thereof; the wireless link is preferably implemented in a manner akin to a mobile telephone and/or proprietary Blue-Tooth. The remote terminal 20 is preferably implemented as a data medium player, for example a DVD player.

The terminal 20 includes a computer processor (CPU) 60 coupled to a local memory device 70 and a user interface 80. The processor (CPU) 60 is preferably operable to provide a Java Virtual Machine for executing one or more Java software applications. Moreover, the user interface 80 is operable to interact with a user 90 of the terminal 20. Moreover, the user interface 80 comprises at least one of:
(a) a visual interface for presenting an image to the user 90, for example a pixel liquid crystal display (LCD);
(b) a visual sensor for visually monitoring the user 90, for example a miniature digital camera;
(c) an acoustic sensor for recording sound in the vicinity of the user 90, for example a microphone;
(d) an acoustic transducer for generating acoustic sound for the user 90, for example a diaphragm loudspeaker or a piezoelectric (PZT) sound-generating element; and
(e) one or more control switches and/or sensors that can be actuated by the user 90 to input data into the terminal 20, for example an array of pushbuttons.

The local memory device 70 is one or more of a magnetic hard disc drive (HDD) memory and an optical disc memory; more preferably, the disc memory is a proprietary “Blu-ray” disc drive devised by the Philips Corporation in the Netherlands. Beneficially, the memory device 70 is capable of receiving removable data carriers such as proprietary “Blu-ray” ROMs. Additionally, or alternatively, the memory device 70 includes a non-volatile solid-state memory, for example a data cache for short-term data buffering.

In a first preferred embodiment, the terminal 20 is arranged to be a “Play-Station” on which the user 90 can play games. Children are regular users of the terminal 20 and it is therefore desirable to prevent them from accessing certain categories of Internet data content, for example violent scenes and erotic scenes.

In a second preferred embodiment, the terminal 20 is a portable handheld shopping device to assist the user 90 in selecting goods for purchase. It is desirable to prevent software applications from loading from the one or more servers 50. Said applications can cause the processor 60 to download purchase choices made by the user 90 and thereby violate the user's privacy.

In a third preferred embodiment, the terminal 20 is an emergency assistance device employed by paramedics when attending accident scenes. The aforementioned visual sensor of the interface 80 may be used to send images of a crash scene to a remote locality, for example to a hospital, for independent assessment and preparation in situ for receiving crash victims; where horrific or embarrassing images of a crash victim's body are communicated through the terminal 20 to the infrastructure 40, it is desirable that third party software applications are not inadvertently downloaded to the terminal 20 communicating such horrific or embarrassing images to a third party, for example a newspaper, which subsequently could divulge such images to the public in an unauthorized manner.

In a fourth preferred embodiment, the terminal 20 is a portable DVD-player capable of receiving DVD data carriers, for example implemented in contemporary “Blu-Ray”-type optical disc format.

Operation of the network 10 will now be described with reference to FIG. 1.

The computer processor 60 executes operating system (OS) software which enables it to create an environment within the terminal 20 in which one or more software applications, for example applications including Internet access APIs, are capable of executing; the operating system is preferably stored in a user-inaccessible ROM incorporated into the terminal 20 during manufacture; more preferably, the operating system (OS) is implemented to include a Java Virtual Machine capable of executing Java software applications including Internet APIs. Amongst other features, the operating system (OS) is operable to load software applications from one or more data carriers inserted into the memory device 70 to run on the processor 60. The loaded software applications communicate to the user 90 via the interface 80 and also access data content stored in the inserted data carriers. As elucidated in the foregoing, the loaded software applications are also capable of communicating via the communication link 30 with the one or more servers 50 to access at least data and/or executable software applications, for example software APIs, therefrom. Such data and/or executable software applications are then loaded via the communication link 30 into random access memory (RAM) of the processor 60; in the case of executable software applications, they are executed by the processor 60 to present subject matter to the user 90.

Software applications executing on the processor 60 are preferably arranged to be “seamless” to the user 90 in respect of whether they are accessing data from the local memory device 70 or data from the infrastructure 40. Such a seamless operation is to be distinguished from a contemporary personal computer (PC) where a user thereof explicitly invokes browser software applications for purposes of accessing the Internet or similar data communication networks and the user is therefore aware of when the user's computer is downloading data content; such an aspect fundamentally distinguishes the present invention from conventional computers arranged to execute explicitly invoked browser software applications for accessing communication networks such as the Internet. However, seamless operation of the terminal 20 is also problematical in that rogue software applications can potentially be unintentionally downloaded from the infrastructure 40 and/or from the memory device 70 and run concurrently in the terminal 20, accessing data content stored in the memory device 70 or downloading images and/or sounds recorded by the interface 80 and passing these on via the communication link 30 to the infrastructure 40, where it can be accessed by third parties, thereby violating user privacy. Where data content stored on the memory device 70 pertains to private information, such rogue software applications can also violate user privacy by making such private information accessible.

In addition to privacy issues, selectively preventing Internet access from the terminal 20 is desirable where Internet access is charged to the user 90 on a byte-basis when the user 90 merely desires to watch a movie on the interface 80, the movie being recorded on a data carrier inserted into the memory device 70.

As elucidated in the general overview above, the terminal 20 is arranged to use configuration parameters to control an extent to which software applications executing on the processor 60 are capable of accessing and/or accepting data content from the infrastructure 40, for example from the Internet. Preferably, the configuration parameters are graded to permit the following categories of access:
(A) no access to the infrastructure 40, for example no access to the Internet;
(B) access to the infrastructure 40 (for example the Internet) subject to express approval from the user 90 only, for example by presenting the user 90 with a visual selection option on the interface 80 to which the user 90 responds by operating a switch (not shown) on the terminal 20, thus indicating whether or not to proceed and access the infrastructure 40; optionally, the aforesaid visual selection option includes Uniform Resource Locator (URL) details presented of a site in the infrastructure 40 (for example an Internet web site) for which permission from the user 90 is desired;
(C) access to the infrastructure 40 (for example the Internet) only if a site therein to be accessed is included in an approved list recorded in the terminal 20; the list is preferably implemented as a list of URLs, while the infrastructure 40 corresponds to the Internet; and
(D) access rights associated with one or more of the user's data carriers, for example Blu-ray optical memory disc, insertable into the memory device 70.

The categories of access (A) to (D) are not mutually exclusive, for example the category (B) can be invoked in conjunction with the categories (C) and (D). In particular, the category (C) concerning a list of approved URLs may be all the URLs that the user 90 is permitted to approve for access in the category (B). By using the configuration parameters complying with one or more of the categories (A) to (D), the user 90 can allow access to certain Internet domains, for example movie studio web sites, and not to others, for example advertising and tracking sites.

The aforementioned configuration parameters can be set by the user. Alternatively, or additionally, the configuration parameters are provided or set during manufacture of the terminal 20. Thus, as shown in FIG. 2, a first data carrier 200a capable of being accepted by the memory device 70 is configured for the categories (B), (C), and (D), whereas a second such data carrier 200b is configured for the category (A) only.

The terminal 20 is capable of being arranged to function so that the user 90 can set a default option for the configuration parameters and also to amend the configuration parameters for a current session of use of the terminal 20. Such amended configuration parameters can be preferably set by the user for each data carrier, for example an optical disc ROM, or until the terminal 20 is switched off after a session of use by the user 90.

In one preferred embodiment of the invention, the configuration parameters can be selected from a configuration menu presented on the interface 80 to the user 90, for example in a manner akin to setting a default language in MicroSoft Windows computer environments; “Windows” is a trade mark of MicroSoft Corporation.

The terminal 20 is preferably operable to remember changes to the configuration parameters implemented by the user 90 with regard to a given data carrier, for example an optical disc inserted into the memory device 70, for further use when the given data carrier is subsequently reinserted into the terminal 20.

In the category (C) above, the user 90 is preferably permitted to add URLs to the list either through confirmation of URL options presented on the interface 80, for example in a subsidiary list of optionally invocable URLs, or in that the user 90 inputs URL details, for example with an alphanumerical keypad in a manner similar to that in which SMS messages are entered on mobile telephones nowadays.

It will be appreciated that embodiments of the invention described in the foregoing are susceptible to modification without departing from the scope of the invention.

In the foregoing, and also with regard to the appended claims, expressions such as “include”, “comprise”, “contain”, “incorporate”, “have” and “is” are to be construed non-exclusively, namely allowing for one or more items or components not explicitly disclosed also to be present. Reference to the singular is also to be construed as referring to the plural and vice versa.

1. A method of controlling access to a communication network (40, 50), characterized in that the method includes the steps of:
(a) providing a device (20) that can be communicatively coupled to the network (40, 50), the device (20) being arranged to include computing means (60) coupling to associated local data storing means (70, 200a, 200b);
(b) arranging for the computing means (60) to execute one or more software applications therein which are at least in part operable in a substantially seamless manner to a user (90) of the device (20) for accessing data content from one or more of the local storing means (70, 200a, 200b) and the network (40, 50);
(c) arranging for the computing means (60) to be at least partially restricted regarding data content that it is capable of receiving from the network (40, 50) and/or requesting from the network (40, 50).

2. A method according to claim 1, wherein the device (20) is arranged to communicate with the network (40, 50) by software means other than one or more browser software applications.

3. A method according to claim 1, wherein the device (20) is capable of being restricted according to one or more of the following categories:
(d) access/no access to the network (40, 50);
(e) access to the network (40, 50) subject to user (90) authorization;
(f) access to the network (40, 50) as defined in a parameter list maintained in association with the device (20); and
(g) access to the network (40, 50) as defined in association with a given data carrier (200a, 200b) compatible with the storing means (70).

4. A method according to claim 3, wherein in step (e) the user (90) is presented with a choice of whether or not to authorize on at least a first occasion that a new given data content delivering site (50) in the network (40, 50) is to be accessed.

5. A method according to claim 4, wherein the user (90) is presented with one or more Uniform Resource Locators (URL) that he/she can authorize the device (20) to access.

6. A method according to claim 1, wherein the device (20) can be set to be subject to a default degree of access to the network (40, 50) which can be overridden by at least one of:
(h) user's (90) choice; and
(i) degree of access determined in association with a given data carrier presented to the storing means.

7. A method according to claim 6, wherein the device (20) is operable to return to a default state of access to the network (40, 50) when one or more of the following states have arisen: re-booted or powered down.

8. A method according to claim 1, wherein the degree of access to the network (40, 50) is dependent upon one or more data carriers presented to the storing means.

9. A method according to claim 1, wherein the partial restriction applied to the computing means (60) in step (c) is arranged to at least partially prevent those software applications from being downloaded from the network (40, 50) to the device (20) which are executable on the computing means (60) to enable access from the network (40, 50) to data content present in the device (20).

10. A method according to claim 1, wherein the network (40, 50) corresponds to the Internet and the device (20) is a portable handheld apparatus, more preferably an optical disc data medium player or a DVD-player.

11. A method according to claim 1, wherein the storing means (70) is arranged to accept one or more optical memory discs, electronic memory modules, and magnetic discs as data carriers to provide executable software applications and/or data content to the computing means (60).

12. A device (20) for communicating with a communication network (40, 50), characterized in that the device (20) is arranged to include computing means (60) coupling to associated local data storing means (70, 200a, 200b), the computing means (60) being operable in a substantially seamless manner to a user (90) of the device (20) for executing one or more software applications therein which are at least in part capable of accessing data content from one or more of the local storing means (70, 200a, 200b) and the network (40, 50), and the computing means (60) is arranged to be at least partially restricted regarding data content that it is capable of receiving from the network (40, 50) and/or requesting from the network (40, 50).
